(19) United States
(12) Patent Application Publication
(10) Pub. No.: US 2022/0299789 A1
(43) Pub. Date: Sep. 22, 2022

(54) STEREOSCOPIC DISPLAY DEVICE

(71) Applicant: Acer Incorporated, New Taipei City (TW)

(72) Inventors: Yi-Jung Chiu, New Taipei City (TW); Shih-Ting Huang, New Taipei City (TW); Yen-Hsien Li, New Taipei City (TW); Tsung-Wei Tu, New Taipei City (TW); Wei-Kuo Shih, New Taipei City (TW)

(73) Assignee: Acer Incorporated, New Taipei City (TW)

(21) Appl. No.: 17/234,812

(22) Filed: Apr. 20, 2021

(30) Foreign Application Priority Data
Mar. 22, 2021 (TW) 110110200

(51) Int. Cl. G02B 30/27; G02B 3/00; G02B 30/22

(52) U.S. Cl. CPC G02B 30/27; G02B 3/0006; G02B 30/22

(57) ABSTRACT

A stereoscopic display device including a display panel and an optical element is provided. The optical element is disposed on a display surface of the display panel. The optical element includes a lenticular lens array. The lenticular lens array includes a plurality of lenticular lenses extending in a first direction. The lenticular lenses are arranged in a second direction. The optical element includes a center line extending in the first direction. The lenticular lenses include a first lenticular lens and a second lenticular lens. The distance between the first lenticular lens and the center line is smaller than the distance between the second lenticular lens and the center line, and the curvature of the first lenticular lens is greater than the curvature of the second lenticular lens.

### CROSS-REFERENCE TO RELATED APPLICATION

This application claims the priority benefit of Taiwan application serial no. 110110200, filed on Mar. 22, 2021. The entirety of the above-mentioned patent application is hereby incorporated by reference herein and made a part of this specification.

### BACKGROUND

### Technical Field

The disclosure relates to a display device, and in particular to a stereoscopic display device.

### Description of Related Art

Currently, a stereoscopic image can be presented by using different methods. Generally, stereoscopic image display devices can be categorized into stereoscopic displays that need to be used with glasses and naked-eye stereoscopic displays. In a naked-eye stereoscopic display, an optical element, such as a disparity grating or a biconvex lens, may be installed at the front part of a display screen to separate optical axes of a left disparity image and a right disparity image. However, when an angle of view is large, crosstalk exists between the left disparity image and the right disparity image, so that it is difficult to separate the left right disparity image and the right disparity image, and the effect of the stereoscopic display is thus reduced.

### SUMMARY

The disclosure provides a stereoscopic display device including an optical element. The stereoscopic display device has low image crosstalk and provides a good stereoscopic display effect.

An embodiment of the disclosure proposes a stereoscopic display device including a display panel and an optical element. The optical element is disposed on a display surface of the display panel. The optical element includes a lenticular lens array. The lenticular lens array includes a plurality of lenticular lenses extending in a first direction. The lenticular lenses are arranged in a second direction. The optical element includes a center line extending in the first direction. The lenticular lenses include a first lenticular lens and a second lenticular lens. A distance between the first lenticular lens and the center line is smaller than a distance between the second lenticular lens and the center line. A curvature of the first lenticular lens is greater than a curvature of the second lenticular lens.

In the stereoscopic display device according to the embodiments of the disclosure, through allowing the lenticular lens in the lenticular lens array that is farther from the center line to have a smaller curvature, the optical path of the image beam can be adjusted, so that the lenticular lenses on the two sides of the stereoscopic display device project each sub-image to the eyes more accurately, so as to reduce crosstalk between images, thereby improving the stereoscopic display effect in the edge region.

### BRIEF DESCRIPTION OF THE DRAWINGS

FIG. 1A is a perspective diagram of a stereoscopic display device according to an embodiment of the disclosure.

FIG. 1B is a schematic cross-sectional diagram of the stereoscopic display device in FIG. 1A.

FIG. 2A is a schematic diagram of a stereoscopic display device according to a comparative example.

FIGS. 2B and 2C are schematic diagrams of partial optical paths of the stereoscopic display device of FIG. 2A.

FIG. 3A is a schematic diagram of a stereoscopic display device according to an embodiment of the disclosure.

FIGS. 3B and 3C are schematic diagrams of partial optical paths of the stereoscopic display device of FIG. 3A.

### DESCRIPTION OF THE EMBODIMENTS

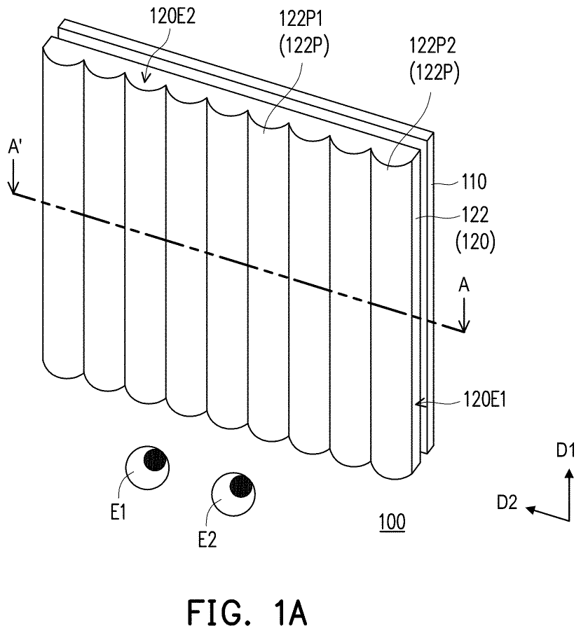

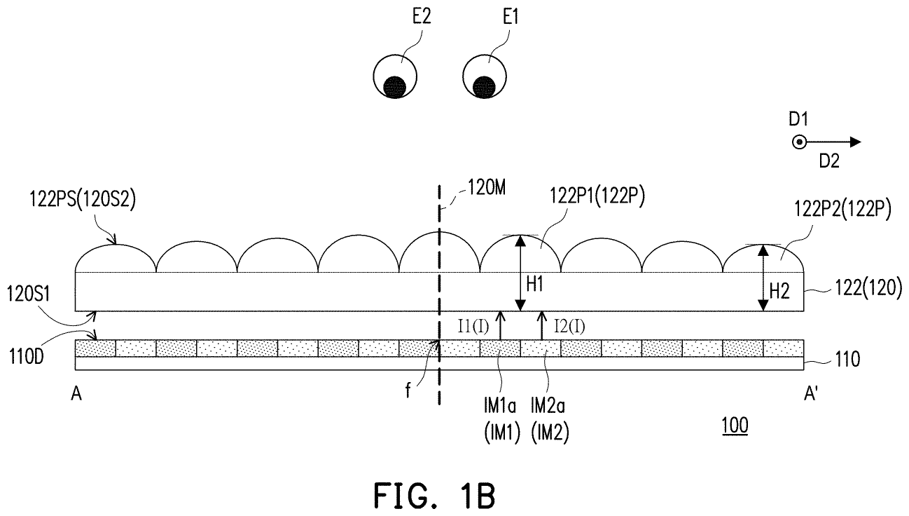

FIG. 1A is a perspective diagram of a stereoscopic display device according to an embodiment of the disclosure. FIG. 1B is a schematic cross-sectional diagram of the stereoscopic display device in FIG. 1A. FIG. 1B is a schematic cross-sectional diagram of a stereoscopic display device 100 in FIG. 1A along a section line A-A′. Referring to FIGS. 1A and 1B, the stereoscopic display device 100 according to the embodiment includes a display panel 110 and an optical element 120. The display panel 110 may be a liquid crystal display panel, a light emitting diode display panel, an organic light emitting diode display panel, or other types of display panels, and the disclosure is not limited thereto.

The optical element 120 is disposed on a display surface 110D of the display panel 110. The display panel 110 may emit an image beam I from the display surface 110D. The image beam I penetrates the optical element 120 and enters eyes E1 and E2 of a user to present a stereoscopic image. In this embodiment, the optical element 120 includes a lenticular lens array 122. The lenticular lens array 122 includes a plurality of lenticular lenses 122P extending in a first direction D1. The lenticular lens 122P is, for example, a positive lenticular lens. The lenticular lenses 122P are arranged in a second direction D2 to form the lenticular lens array 122. In this embodiment, the first direction D1 is perpendicular to the second direction D2, but the disclosure is not limited thereto. In other embodiments, the first direction D1 and the second direction D2 may not be perpendicular to each other. In an embodiment, when the user faces the stereoscopic display device 100 to look at an image, the first direction D1 is substantially parallel to the left and right direction of the viewpoint of the user. A material of the optical element 120 is plastic, acrylic, glass or a hybrid thereof. The material of the optical element 120 may be other light penetrating materials, too, and the disclosure is not limited thereto. In an embodiment, the optical element 120 is integrally formed. For example, each part of the optical element 120 may be integrally formed in a single process, but the disclosure is not limited thereto.

The optical element 120 includes a first edge 120E1 substantially parallel to the first direction D1 and a second edge 120E2 substantially parallel to the second direction D2. The optical element 120 may include a center line 120M extending in the first direction D1. In an embodiment, the center line 120M passes through the center of the second edge 120E2, but the disclosure is not limited thereto. In an embodiment, the optical element 120 is axially symmetrical to the center line 120M, but the disclosure is not limited thereto.

The lenticular lenses 122P of the lenticular lens array 122 include a first lenticular lens 122P1 and a second lenticular lens 122P2. In this embodiment, the distance between the first lenticular lens 122P1 and the center line 120M is smaller than the distance between the second lenticular lens 122P2 and the center line 120M, and the curvature of the first lenticular lens 122P1 is greater than the curvature of the second lenticular lens 122P2. That is, the lenticular lens in the lenticular lens array 122 that is farther from the center line 120M has a smaller curvature (that is, a larger curvature radius). The curvature of the lenticular lens is the curvature at the vertex of the curve of the surface of the lenticular lens on a cross section perpendicular to the first direction D1.

In the stereoscopic display device 100 according to this embodiment, by allowing the lenticular lens in the lenticular lens array 122 that is farther from the center line 120M to have a smaller curvature, the optical path of the image beam may be adjusted according to the distribution position of the lenticular lenses, so that the lenticular lens closer to the edge region of the stereoscopic display device 100 (or the region where the angle of view is larger) may project each sub-image (for example, the left disparity image and the right disparity image) to the eyes more accurately, thereby reducing crosstalk between the left disparity image and the right disparity image and improving the stereoscopic display effect.

It should be noted that FIG. 1A is a schematic perspective diagram of the stereoscopic display device 100, and does not specifically show a curvature change of the lenticular lenses 122P. FIG. 1B schematically illustrates one curvature change of the lenticular lenses 122P. In other embodiments, the curvatures of the lenticular lenses may be adjusted according to needs, so there may be various curvature changes of the lenticular lenses. In addition, FIGS. 1A and 1B illustrate a specific number of lenticular lenses, but the number of lenticular lenses included in the optical element may be adjusted according to actual needs, and the disclosure is not limited thereto.

In an embodiment, the optical element 120 includes a first surface 120S1 facing the display panel 110 and a second surface 120S2 facing the display panel 110. The first surface 120S1 is a smooth surface. The second surface 120S2 includes lenticular lens surfaces 122PS. That is, the lenticular lenses 122P are disposed on a side of the optical element 120 close to the second surface 120S2, and the surfaces of the lenticular lenses 122P form a part of the second surface 120S2, but the disclosure is not limited thereto. In addition, in an embodiment, the first surface 120S1 directly contacts the display panel 110 or is directly attached to the display panel 110 so as to simplify the process or to optimize the optical effect, but the disclosure is not limited thereto.

In an embodiment, the focal length of the first lenticular lens 122P1 is smaller than the focal length of the second lenticular lens 122P2. That is, the lenticular lens in the lenticular lens array 122 that is farther from the center line 120M has a larger focal length, and may project each sub-image to the eyes more accurately, thereby improving the stereoscopic display effect, but the disclosure is not limited thereto.

In an embodiment, a thickness H1 of the optical element 120 at the first lenticular lens 122P1 is greater than a thickness H2 of the optical element 120 at the second lenticular lens 122P2. The thickness of the optical element 120 is the distance from the vertex of the lenticular lens surface 122PS (for example, the vertex of the curve of the lenticular lens surface 122PS on a cross section perpendicular to the first direction DO to the first surface 120S1. In the embodiment where the first surface 120S1 directly contacts the display panel 110 or is directly attached to the display panel 110, the thickness of the optical element 120 is the distance from the vertex of the lenticular lens surface 122PS to the display surface 110D of the display panel 110. In an embodiment, in the direction along the second edge 120E2, the middle part of the optical element 120 is thicker and two sides of the optical element 120 are thinner.

In an embodiment, the curvatures of the lenticular lenses 122P decrease from the center line 120M to the two sides. For example, among two adjacent lenticular lenses 122P, the curvature of the lenticular lens 122P farther from the center line 120M may be the same or smaller than the curvature of the other lenticular lens 122P. Therefore, the optical path of the image beam may be adjusted according to a change in the angle of view of the lenticular lenses, but the disclosure is not limited thereto.

In an embodiment, the lenticular lens surface 122PS is a non-cylindrical surface so as to obtain a good stereoscopic display effect. That is, the lens curve of the lenticular lens surface 122PS on a cross section perpendicular to the first direction D1 may be defined by the following formula:

$$Z ( x ) = \frac{{cx}^{2}}{1 + \sqrt{1 - ( 1 + k ) {cx}^{2}}} + {a}_{2} {x}^{2} + {a}_{4} {x}^{4} + {a}_{6} {x}^{6} + {a}_{8} {x}^{8} + ⋯ \qquad ( 1 )$$

in which:

Z is the depth of the lens curve;

x is the distance between a point on the lens curve and the lens center axis;

c is the curvature at the lens center axis, which is the reciprocal of the curve radius at the lens center axis;

k is a conic constant;

a2, a4, a6, a8 . . . are aspherical even-order constants (there are no odd-order constants).

Each constant (including but not limited to the curvature c, the conic constant k, the aspherical even-order constants a2, a4, a6, a8 . . . etc.) of each of the lenticular lenses 122P may be adjusted according to actual needs so as to adjust the surface type of the lenticular lens surfaces 122PS, so that the stereoscopic display device 100 may provide a better stereoscopic display effect, but the disclosure is not limited thereto. In other embodiments, the lenticular lens surface 122PS may be a cylindrical surface.

In an embodiment, the display panel 110 is disposed on a focal point f of at least one of the lenticular lenses 122P (for example, the lenticular lens 122P located at the center line 120M), so that the image beam I from the display panel 110 may be projected substantially parallel to the eyes E1 and E2 of the user after penetrating the lenticular lens 122P, so as to present a stereoscopic image.

In an embodiment, the display panel 110 presents at least two sub-images IM1 (for example, the left disparity image) and IM2 (for example, the right disparity image) at the same time. The left disparity image IM1 and the right disparity image IM2 may each include a plurality of bar-type blocks, and the bar-type blocks of the left disparity image IM1 and the bar-type blocks of the right disparity image IM2 are disposed in an interleaved manner. An image beam I1 emitted from a bar-type block IM1a in the left disparity image IM1 penetrates a lenticular lens (for example, the first lenticular lens 122P1), and is projected to the eye E1 (for example, the left eye) of the user; and an image beam 12 emitted from a bar-type block IM2a in the right disparity image IM2 that is adjacent to the bar-type block IM1a penetrates the first lenticular lens 122P1, too, and is projected to the other eye E2 (for example, the right eye) of the user, to present a stereoscopic image. That is, the first lenticular lens 122P1 corresponds to a part of the left disparity image IM1 (for example, the bar-type block IM1a) and a part of the right disparity image IM2 (for example, the bar-type block IM2a). This embodiment shows two sub-images, and other embodiments may include more than two sub-images. One lenticular lens may correspond to a part of each of the sub-images.

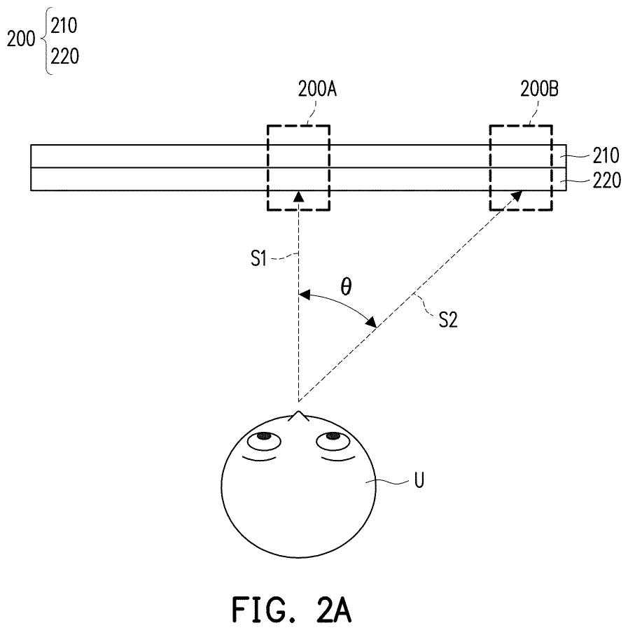

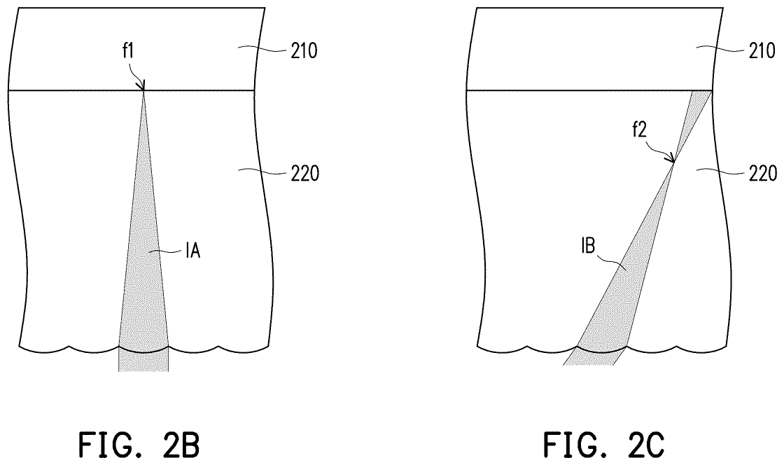

FIG. 2A is a schematic diagram of a stereoscopic display device according to a comparative example. Referring to FIG. 2A, a stereoscopic display device 200 includes a display panel 210 and an optical element 220. The display panel 210 and the optical element 220 are similar to the display panel 110 and the optical element 120. The difference is that in the optical element 220, the curvatures of a plurality of lenticular lenses are fixed.

The stereoscopic display device 200 includes a central region 200A located at the central part of the display device 200, and a peripheral region 200B near the edge of the display device 200. In an example, a user U looks directly at the central region 200A (along a line of sight S1), and looks at the peripheral region 200B (along a line of sight S2) through an angle of view θ.

FIG. 2B is a schematic diagram of a partial optical path in the central region 200A of the stereoscopic display device 200. FIG. 2C is a schematic diagram of a partial optical path in the peripheral region 200B of the stereoscopic display device 200. Referring to FIG. 2B, in the central region 200A, a focal point f1 of the optical element 220 falls on the display panel 210.

Therefore, an image beam IA from the display panel 210 may be projected substantially parallel to the eyes of the user U after penetrating the optical element 220, so as to present a stereoscopic image.

Referring to FIG. 2C, in the peripheral region 200B, a focal point f2 of the optical element 220 does not fall on the display panel 210. The focal point f2 is the point where the parallel beams parallel to the line of sight S2 converge. Therefore, after an image beam IB from the display panel 210 intersects in the optical element 220, the image beam IB is projected substantially parallel to the eyes of the user U. Therefore, when the user U looks at the peripheral region 200B through the angle of view θ, crosstalk exists in the image seen by the user U.

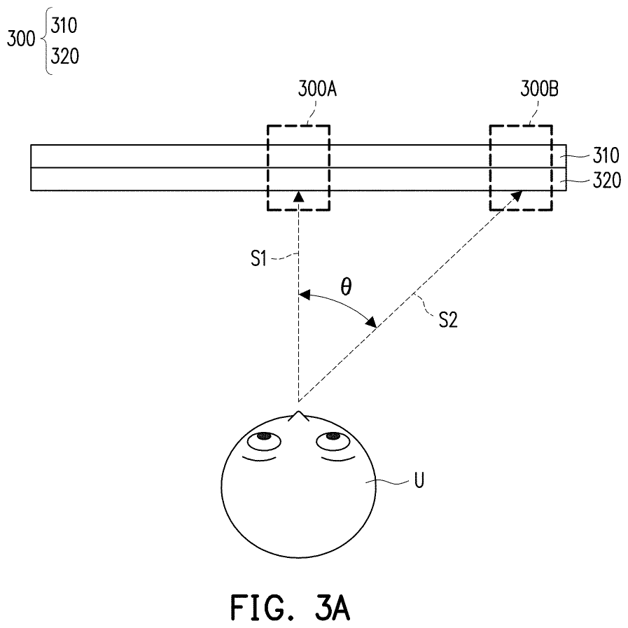

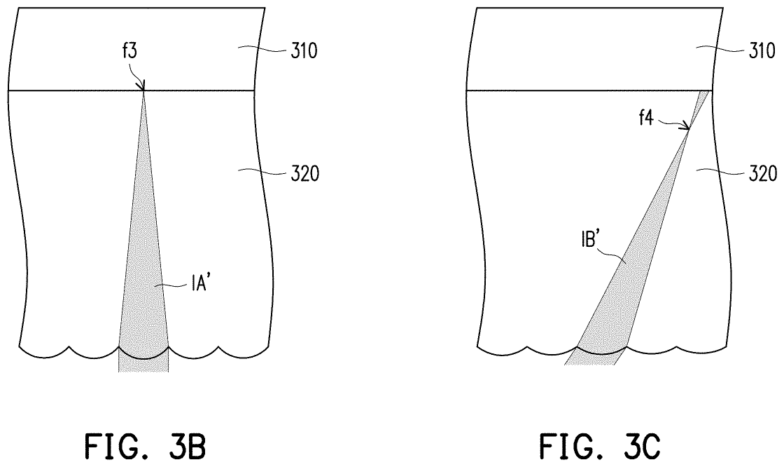

FIG. 3A is a schematic diagram of a stereoscopic display device according to an embodiment of the disclosure. Referring to FIG. 3A, a stereoscopic display device 300 includes a display panel 310 and an optical element 320. The stereoscopic display device 300 is similar to the stereoscopic display device 100.

The stereoscopic display device 300 includes a central region 300A located at the central part of the display device 300, and a peripheral region 300B near the edge of the display device 300. In an example, the user U looks directly at the central region 300A (along the line of sight S1), and looks at the peripheral region 300B (along the line of sight S2) through the angle of view θ.

FIG. 3B is a schematic diagram of a partial optical path in the central region 300A of the stereoscopic display device 300. FIG. 3C is a schematic diagram of a partial optical path in the peripheral region 300B of the stereoscopic display device 300. Referring to FIG. 3B, in the central region 300A, a focal point f3 of the optical element 320 falls on the display panel 310. Therefore, an image beam IA′ from the display panel 310 may be projected substantially parallel to the eyes of the user U after penetrating the optical element 320, so as to present a stereoscopic image.

Referring to FIG. 3C, compared with the situation in the peripheral region 200B, in the peripheral region 300B, a focal point f4 of the optical element 320 is closer to the display panel 310. The focal point f4 is the point where the parallel beams parallel to the line of sight S2 converge. Therefore, although an image beam IB′ from the display panel 310 intersects in the optical element 320, too, before being projected substantially parallel to the eyes of the user U, since the intersection point is closer to the display panel 310, the intersection has less influence on the image beam IB′. Therefore, when the user U looks at the peripheral region 300B through the angle of view θ, the crosstalk effect in the image is lower than that in the peripheral region 200B of the stereoscopic display device 200, and thus the stereoscopic display effect is better. In an embodiment, parameters of the lenticular lenses may be designed so that along the line of sight from all angles, the focal point of the optical element falls on the display panel, but the disclosure is not limited thereto.

In summary, in the stereoscopic display device according to the embodiments of the disclosure, through allowing the lenticular lens in the lenticular lens array that is farther from the center line to have a smaller curvature, the optical path of the image beam may be adjusted, so that the lenticular lens closer to the edge region (or the region where the angle of view is larger) in the stereoscopic display device may project each sub-image to the eyes more accurately, so as to reduce crosstalk between images, thereby improving the stereoscopic display effect.

What is claimed is:

1. A stereoscopic display device, comprising:
a display panel; and
an optical element, disposed on a display surface of the display panel, wherein the optical element comprises a lenticular lens array, the lenticular lens array comprises a plurality of lenticular lenses extending in a first direction, and the lenticular lenses are arranged in a second direction;
wherein the optical element comprises a center line extending in the first direction, the lenticular lenses comprise a first lenticular lens and a second lenticular lens, a distance between the first lenticular lens and the center line is smaller than a distance between the second lenticular lens and the center line, and a curvature of the first lenticular lens is greater than a curvature of the second lenticular lens.

2. The stereoscopic display device according to claim 1, wherein a focal length of the first lenticular lens is smaller than a focal length of the second lenticular lens.

3. The stereoscopic display device according to claim 1, wherein a thickness of the optical element at the first lenticular lens is greater than a thickness of the optical element at the second lenticular lens.

4. The stereoscopic display device according to claim 1, wherein curvatures of the lenticular lenses decrease from the center line to two sides.

5. The stereoscopic display device according to claim 1, wherein the optical element comprises a first surface facing the display panel and a second surface facing away from the display panel, wherein the second surface comprises surfaces of the lenticular lenses, and the first surface is a smooth surface, wherein the first surface directly contacts the display panel or is directly attached to the display panel.

6. The stereoscopic display device according to claim 1, wherein surfaces of the lenticular lenses are non-cylindrical surfaces.

7. The stereoscopic display device according to claim 1, wherein surfaces of the lenticular lenses are cylindrical surfaces.

8. The stereoscopic display device according to claim 1, wherein the display panel is disposed on a focal point of at least one of the lenticular lenses.

9. The stereoscopic display device according to claim 1, wherein the display panel respectively presents at least two sub-images at the same time.

10. The stereoscopic display device according to claim 9, wherein the first lenticular lens corresponds to a part of each of the sub-images.

11. The stereoscopic display device according to claim 1, wherein a material of the optical element is plastic, acrylic, glass, or a hybrid thereof.

12. The stereoscopic display device according to claim 1, wherein the optical element is integrally formed.

13. The stereoscopic display device according to claim 1, wherein the display panel is a liquid crystal display panel, a light emitting diode display panel, or an organic light emitting diode display panel.

14. The stereoscopic display device according to claim 1, wherein the display panel is configured to emit an image beam, and the image beam penetrates the optical element and enters eyes of a user to present a stereoscopic image.

15. The stereoscopic display device according to claim 1, wherein the lenticular lenses are positive lenticular lenses.

16. The stereoscopic display device according to claim 1, wherein the first direction is perpendicular to the second direction.
